(19) United States
(12) Patent Application Publication
(10) Pub. No.: US 2011/0270935 A1
(43) Pub. Date: Nov. 3, 2011

(54) COMMUNICATION DEVICE, INFORMATION COMMUNICATION SYSTEM, METHOD FOR CONTROLLING COMMUNICATION OF COMMUNICATION DEVICE AND PROGRAM THEREFOR

(75) Inventors: Akihiro Tozaki, Kanagawa (JP); Takehiko Shioda, Kanagawa (JP); Kazunori Hashimoto, Saitama (JP); Kunihiro Minoshima, Kanagawa (JP); Nobuhiro Ishizuka, Kanagawa (JP); Ken Murayama, Kanagawa (JP); Junichi Shirakawa, Osaka (JP); Shuji Daioku, Osaka (JP); Nobuo Kusumoto, Osaka (JP)

(73) Assignee: PIONEER CORPORATION, Kanagawa (JP)

(21) Appl. No.: 12/998,073

(22) PCT Filed: Jul. 30, 2009
(86) PCT No.: PCT/JP2009/003620

§ 371 Date: May 16, 2011

(30) Foreign Application Priority Data
Sep. 16, 2008 (JP) 2008-235988

(51) Int. Cl. G06F 15/16

(52) U.S. Cl. 709/206

(57) ABSTRACT

A communication (on-board) device 10 of the invention has: a communication unit 110 communicating with a portable device 30; an unconfirmed information obtaining unit 120 obtaining unconfirmed information from the portable device 30 which a user has not confirmed at the portable device 30 at the time of communication establishment by the communication unit 110; and an information output unit 150 displaying or outputting audibly the obtained unconfirmed information. In this case, it is preferable that unread mail information regarding one or more electronic mails unread at the time of the communication establishment and/or missed call information regarding one or more missed calls received before the communication has been established be obtained as the unconfirmed information.

### TECHNICAL FIELD

The present invention relates to a communication device which is capable of communicating with a portable device, an information communication system, a method for controlling communication of the communication device and a program therefor.

### BACKGROUND ART

Generally, a vehicle-mounted device has been known which is, when a call is made to a cellular phone while a vehicle is moving, a communication device capable of communicating with the cellular phone (portable device) and which can display information (caller's name and phone number, etc) about the caller on a display (for example, patent document 1). With this function, since a driver can confirm that there has been an incoming call and who has called while the driver is driving and cannot talk by phone, it is convenient for the driver because the driver can call back later.

[Patent Document 1] JP-A2005-267809

### DISCLOSURE OF THE INVENTION

### Problems to be Solved

However, in the above patent document, there is described that an incoming call after a communication has been established with the mobile phone is displayed, but there is no description that a missed call which had been received by the mobile phone before the communication was established is displayed. In other words, regarding the known vehicle-mounted device, if a driver rides on a vehicle without noticing that there has been a missed call to the mobile phone, the driver won't check a display of the mobile phone because a hands-free communication is available after the communication between the mobile phone and the vehicle-mounted device has been established. Therefore, there is a possible problem in which it is not until the driver confirms the display of the mobile phone after getting off the vehicle that the driver notices a missed call to the mobile phone.

The invention is made in view of the above problem. Accordingly, an object of the invention is to provide a communication device which can inform a user information unconfirmed by the user in a portable device after a communication is established with the portable device, an information communication system, a communication control method for the communication device and a program.

### Means to Solve the Problems

A communication device of the invention has: a communication unit that communicates with a portable device; an unconfirmed information obtaining unit that obtains from the portable device unconfirmed information which is information unconfirmed by a user on the portable device at a time of communication establishment by the communication unit; and an information output unit that displays or outputs audibly the obtained unconfirmed information.

A communication control method of a communication device of the invention is a communication control method of a communication device which can communicate with a portable device, and the communication device includes steps of: establishing communication with the portable device; obtaining unconfirmed information from the portable device that has been unconfirmed by a user on the portable device at a time of communication establishment; and displaying or outputting audibly the obtained unconfirmed information.

According to these configurations, since information (unconfirmed information) seemed to be unconfirmed by a user is obtained from the portable device at the time of communication establishment and is displayed or output audibly, failure when the portable device is linked can be resolved. In short, even if the user gets on board without noticing unconfirmed information (for example, in a case that the portable device is a cellular phone, information is missed calls) to the portable device, since the information regarding the missed calls is displayed or output audibly after the communication establishment with the communication device, the user can surely confirm the missed calls.

The “unconfirmed information” refers to information which needs a confirmation operation by the user and the confirmation operation has not been performed. For example, in addition to the above missed call information, it might include unread information of electronic mails, various pieces of error information, inquiry information to a user, download confirmation information of applications, and service information such as unread newly arrived news informed from various services.

Further, the “communication device” refers to an electronic device having a communication function and includes a “vehicle-mounted device”, a “wrist watch”, a “personal computer (portable type)” and the like. The “vehicle-mounted device” includes devices (including portable type on-board device) not only fixedly provided on a vehicle but also detachably provided to a vehicle.

In the above described communication device, the portable device includes at least an electronic mail function or a call function, and the unconfirmed information obtaining unit obtains unread mail information regarding one or more unread electronic mails at a time of communication establishment by the communication unit or missed call information regarding one or more missed calls received before the communication establishment by the communication unit as the unconfirmed information.

With this configuration, a user can confirm the unread mail information regarding one or more electronic mails in an unread state at the time of communication establishment and the missed call information regarding one or more missed calls received before the communication establishment.

The “unread mail information” includes information regarding the number of unread mails, a mail received date and time, a sender's name, a sender's (source) address, an electronic mail text, a title, an attached file and the like. Also, the “missed call information” includes information regarding the number of missed calls, a received date and time, a caller's name, a caller's (source) phone number, existence/non-existence of a memo in absence and a message memo, a content of the message memo and the like.

In the communication device descried above, the portable device includes at least the call function and a message recording function, and the unconfirmed information obtaining unit obtains message information regarding one or more message memos recorded by the message recording function in accordance with one or more of the missed calls as at least a portion of the missed call information.

With this configuration, a user can confirm the message information regarding the message memo as at least a portion of the missed call information.

The “message recording function” is equipped in mobile phones and records a voice message of a caller in the portable device. In addition, an “answering phone function” provided as network service by a mobile service provider has been known. It may be possible to obtain the voice message recorded by the “answering phone function” as at least a portion of missed call information.

In the above communication device described above, the device further has an importance degree discrimination unit that discriminates each importance degree of one or more of the electronic mails or of one or more of the missed calls, and the information output unit displays or outputs audibly the unread mail information based on importance degree of one or more of the electronic mails when the portable device includes the electronic mail function, and displays or outputs audibly the missed call information based on importance degree of one or more of the missed calls when the portable device includes the call function.

With this configuration, it is possible to display or output audibly in accordance with importance degree of electronic mails (unread mails) and missed calls.

In terms of the phrase “displays or outputs audibly the unread mail information based on importance degree of one or more of the electronic mails in an unread state”, an output mode of the unread mail information may be changed based on whether a mail exists having high (or low) importance degree among one or more electronic mails, or a mail having only high importance degree among one or more electronic mails may be output as the unread mail information. The output mode includes an output speed, an output order, an output size (in a case of display), letter decoration (in the case of display), output volume (in a case of audio output), output voice (in the case of audio output) and the like.

Also, the output mode may be changed based on the number of electronic mails having high (or low) importance degree included in one or more electronic mails, or existence/non-existence of output of the unread mail information may be determined based on a ratio of electronic mails having high (or low) importance degree in one or more electronic mails. The same holds for the “missed call information”.

In the communication device described above, the information output unit outputs at least information about a sender or a title regarding an electronic mail discriminated as having high degree of importance among one or more of the electronic mails as at least a portion of the unread mail information, and outputs at least information about a caller or a received date and time regarding a missed call discriminated as having high degree of importance among one or more of the missed calls as at least a portion of the missed call information.

With this configuration, regarding an electronic mail discriminated as having high degree of importance, at least information about the sender (sender's name and/or sender's address) or the title (subject) is output, and regarding a missed call discriminated as having high degree of importance, at least information about a caller (caller's name and/or caller's phone number) or a missed call date and time is output. Therefore, a user can effectively confirm necessary information regarding the unconfirmed information in a short time.

In the communication device described above, the device further has a new mail information obtaining unit that obtains new mail information regarding an electronic mail received from the portable device having at least the electronic mail function after communication establishment by the communication unit, and the information output unit displays or outputs audibly the new mail information at a time of obtaining the new mail information.

With this configuration, a user can confirm not only information regarding unread electronic mail at the time of communication establishment but also information regarding an electronic mail received after the communication is established.

The “new mail information” includes a mail received date and time, a sender's name, a sender's (source) address, an electronic mail text, a title, an attached file and the like.

In the communication device described above, the communication device further has an importance degree discrimination unit that discriminates degree of importance of the electronic mail, and the information output unit displays or outputs audibly the new mail information based on degree of importance of the received electronic mail.

With this configuration, it is possible to display or output audibly in accordance with the importance degree of an electronic mail.

Regarding the phrase of “displays or outputs audibly the new mail information based on importance degree of the received electronic mail”, an output mode of the new mail information may be changed or whether the information is output or not may be determined based on importance degree of the electronic mail.

In the communication device described above, the device further has: a text output instruction unit that instructs text output of an electronic mail discriminated as having high degree of importance by the importance degree discrimination unit when the portable device includes the electronic mail function; and a text output unit that displays or outputs audibly a text of the electronic mail discriminated as having high degree of importance based on an instruction from the text output instruction unit.

With this configuration, regarding an electronic mail discriminated as having high importance degree, since text output is available, the content of the electronic mail can be confirmed expeditiously. If texts of all the electronic mails discriminated as having high importance degree are output, a user needs some time to confirm, leading to interference in safety driving. Such a problem can be solved by outputting a text only which the user instructs.

In the communication device described above, the device further has a text output unit that displays or outputs audibly a text of an electronic mail discriminated as having high degree of importance by the importance degree discrimination unit following an output from the information output unit when the portable device includes the electronic mail function.

With this configuration, regarding a text of an electronic mail discriminated as having high importance degree, the text is displayed or output audibly following an output of the unread mail information or the new mail information. Therefore, a user can confirm the content of the electronic mail promptly without a special operation.

Regarding an electronic mail discriminated as having low importance degree, it is preferable that, for example, the text thereof be output after the user arrives at a destination so as not to interfere in safety driving. In other words, in the communication device described above, it is preferable that the device have a destination setting unit that sets a destination and a route guidance unit that navigate a route to the set destination, and the text output unit display or output audibly a text of an electronic mail discriminated as having low importance degree by the importance degree discrimination unit after the route guidance terminates.

In the communication device described above, the device further has a mail output length discrimination unit that discriminates whether text output length of an electronic mail discriminated as having high degree of importance by the importance degree discrimination unit is beyond predetermined output length or not, and the text output unit displays or outputs audibly only a beginning portion of the text when the output length of the electronic mail is beyond the predetermined output length.

In a case that a text of an electronic mail is extremely long, a plenty of time is needed to confirm the content thereof and it is not preferable in view of safety aspect for driving. Therefore, when output length of a text of an electronic mail is beyond predetermined output length, it is possible to solve such a problem by outputting only a beginning portion thereof.

In the communication device described above, when the portable device includes the electronic mail function, the importance degree discrimination unit discriminates degree of importance of the electronic mail based on at least one pieces of information among a priority flag added to the electronic mail, a sender's address and existence/nonexistence for breaking a seal confirmation.

With this configuration, it is possible to discriminate the degree of importance easily based on the priority flag added to the electronic mail, the sender's address and the existence/nonexistence for breaking a seal confirmation and the like.

Regarding the “sender's address”, an address including a predetermined character string may be discriminated as having high importance degree, or the importance degree may be discriminated with reference to a phone book stored in the portable device or the communication device.

In the communication device described above, the communication unit sends output completion information indicating a mail ID of the electronic mail output from the text output unit, and the output completion information is information that makes the portable device render the electronic mail corresponding to the mail ID in an already-read state on receipt of the output completion information.

In the communication device described above, the output completion information is information that renders the output completed portion of the electronic mail corresponding to the mail ID in an already-read state.

With these configurations, since the portable device can make the output completed portion which has been output completely in the communication device in an already-read state, a user can recognize the already read electronic mails and the already read portions thereof. Thus, even though the mails have been read at the communication device it is possible to remove the burden of confirming the same electronic mails again at the portable device.

In the portable device, regarding electronic mails of which whole text has been output completely, since the corresponding mails themselves are made in the already-read state (performing a already-read process) on receipt of the output completion information (electronic mail ID), it is possible to save time to make the unread mails in the already-read state at the portable device.

In the above communication device described above, the portable device includes at least the call function and the message recording function, and the unconfirmed information obtaining unit obtains message information about one or more message memos recorded by the message recording function in accordance with one or more of the missed calls as at least a portion of the missed call information. The device further has a message output instruction unit that instructs to output a message memo of the missed call discriminated as having high degree of importance by the importance degree discrimination unit, and a message output unit that displays or outputs audibly the message memo of the missed call based on an instruction from the message output instruction unit.

With this configuration, a user can confirm message memos recorded on the portable device at the communication device.

In the communication device described above, the communication unit sends output completion information indicating the missed call of which a message memo has been output by the message output unit to the portable device, and the output completion information is information that makes the portable device delete or render in an already reproduced state a message memo corresponding to the missed call on receipt of the confirmation completion information.

With this configuration, since message memos which have been output completely at the communication device can be deleted or be in a reproduced state at the portable device, a user can recognize message memos already confirmed and save time to make the message memos delete or be in the reproduced state.

In the communication device described above, the device further has a confirmation completion information obtaining unit that obtains confirmation completion information indicating the electronic mail or the missed call confirmed after communication establishment by the communication unit from the portable device, and the information output unit deletes information regarding the confirmed electronic mail from the unread mail information or deletes information regarding the confirmed missed call from the missed call information on receipt of the confirmation completion information.

With this configuration, it is possible to recognize that electronic mails or missed calls has been confirmed at the communication device. Further, it is possible to remove the burden of confirming the same information at the communication device, though the information has already been confirmed at the portable device.

An information communication system of the invention has the communication device described above and the portable device.

A program of the present invention instructs a computer to perform each step in the communication control method of the communication device described above.

With these configurations, it is possible to provide an information communication system or a program which can inform information unconfirmed by a user at the portable device to the user by the communication device which has established communication with the portable device.

### BRIEF DESCRIPTION OF THE DRAWINGS

FIG. 1 is a control block diagram of a vehicle-mounted device according to one embodiment of the invention.

FIG. 2 is a functional block diagram of an information communication system according to the first embodiment.

FIG. 3 is a display example of unconfirmed information (an example of an unconfirmed information display screen).

FIG. 4 is a main flowchart explaining an information output process of the vehicle-mounted device.

FIG. 5 is a sub-flowchart of FIG. 4 explaining an unconfirmed information obtaining process.

FIG. 6 is a sub-flowchart of FIG. 4 explaining an unconfirmed information display process.

FIG. 7 is a functional block diagram of an information communication system according to the second embodiment.

FIG. 8 is a flowchart explaining an information output process of a vehicle-mounted device according to the second embodiment.

### BEST MODES FOR CARRYING OUT THE INVENTION

A communication device, an information communication system, a method for controlling communication of the communication device and program therefor according to one embodiment of the invention will be described hereinafter. In the embodiments, a vehicle-mounted device is exemplified as a communication device which has a communication function (especially, a function for obtaining information regarding an electronic mail and an incoming call) with a portable device (for example, a mobile phone) and a car navigation function.

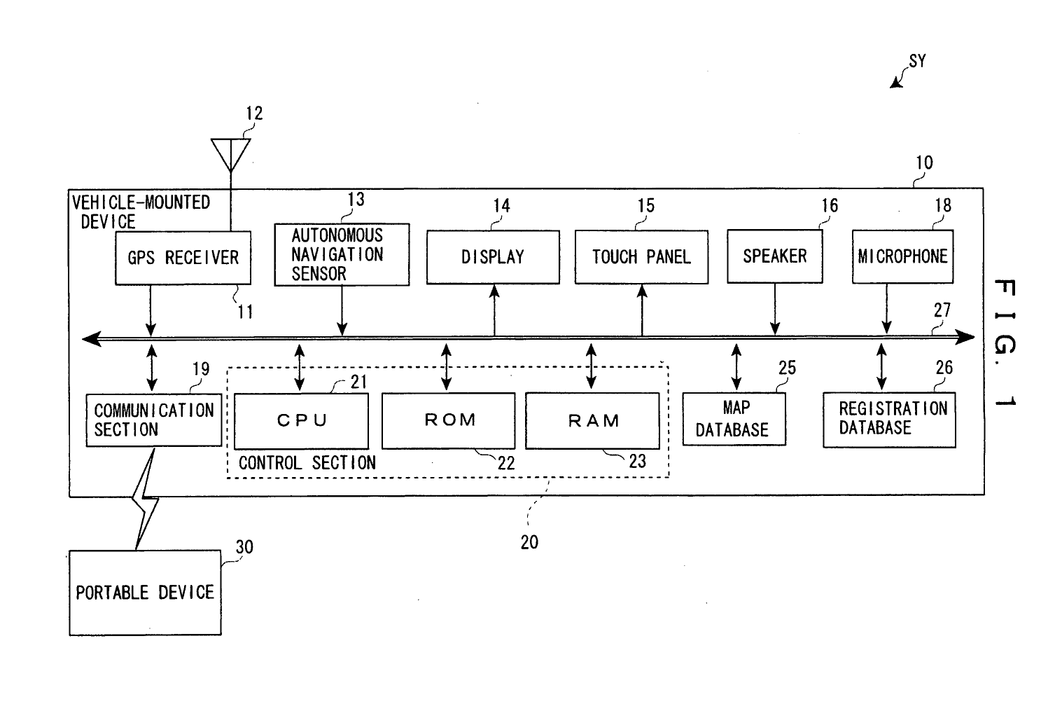

FIG. 1 is a control block diagram of a vehicle-mounted device 10. As shown in FIG. 1, the vehicle-mounted device 10 includes a GPS (Global Positioning System) receiver 11, an antenna 12, an autonomous navigation sensor 13, a display 14, a touch panel 15, a speaker 16, a microphone 18, a communication section 19, a controller 20, a map database 25, a registration database 26, and a connection bus 27.

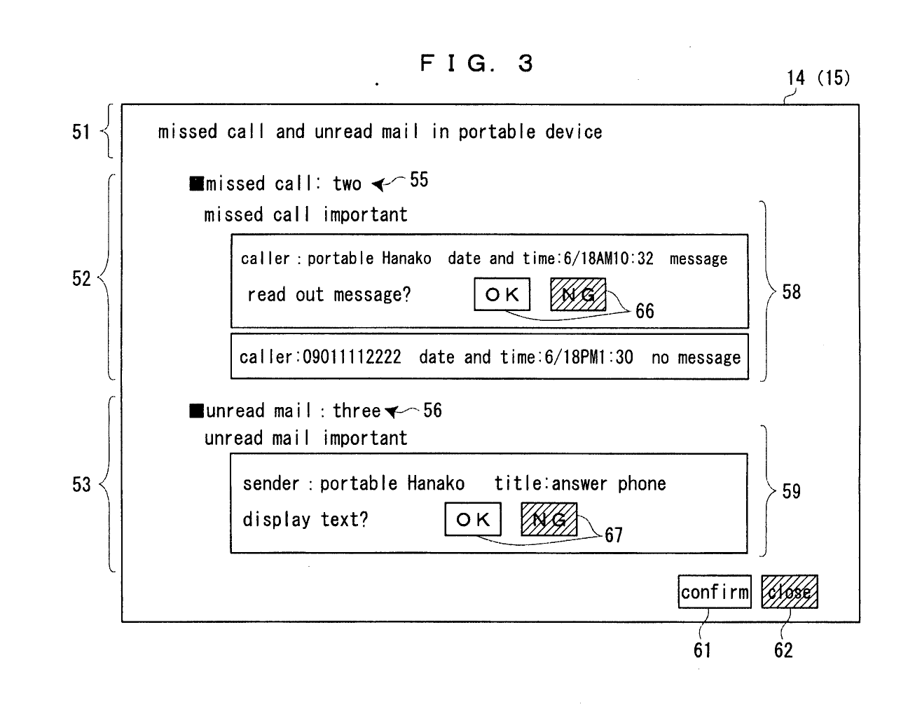

The GPS (Global Positioning System) receiver 11 receives GPS information (including position information and time information) via the antenna 12. The autonomous navigation sensor 13 has an angular sensor and a distance sensor (both are not shown) and is used with the GPS receiver 11 for specifying a current position of a vehicle. The display 14 displays a content (such as a sender, title, information about received time and date, a text of the mail) of an electronic mail obtained through the communication section 19 from a portable device 30 and displays various operation screens (see FIG. 3) as needed. Further, the display 14 displays map information and navigation guidance information when used in route guidance.

The touch panel 15 has a matrix switch provided to overlap on the display 14 and detects a contact by a finger or the like. In the embodiment, the touch panel 15 is mainly used for operation on the above mentioned various operation screens. The speaker 16 notifies audibly a user (driver) that an electronic mail has been received and a call has been received, and a message memo recorded when in a missed call. Further, the speaker 16 performs various pieces of audio confirmation (audio guidance urging a user to select or confirm) as needed, and outputs audio guidance information when in route guidance.

The microphone 18 is used for various operations with handsfree and is used for a selection operation and the like as the touch panel 15. Also, the microphone 18 is used for handsfree call when the portable device 30 is a mobile phone. The communication section 19 performs a close range wireless communication or an infra-red communication with the portable device 30. It may employ a cable communication such as a bus connection in place of these non-contact communications. In the embodiment, the communication section 19 is mainly used for obtaining unread mail information regarding unread mail and missed call information (including message information regarding a message memo recorded in the portable device 30 when a missed call is received) regarding a missed call. Hereinafter, these pieces of the “unread mail information” and the “missed call information” is termed as “unconfirmed information” in a sense that these pieces of information has not been confirmed in the portable device 30.

The controller 20 includes a CPU (Central Processing Unit) 21, a ROM (Read Only Memory) 22 and a RAM (Random Access Memory) 23. The CPU 21 is a central processing unit and processes various calculations. The ROM 22 stores a control program for processing the various calculations by the CPU 21, and the RAM 23 is used for a work area when the CPU 21 processes the various calculations.

The map database 25 stores map data for route guidance in non-volatile. The registration database 26 stores various pieces of registration information and communication record. The registration database 26 stores spot registration information in which a spot has been registered and a telephone book (address book) as the various pieces of registration information. The communication record includes an outgoing record and an incoming record of the phone, and a sending record and a receiving record of electronic mails.

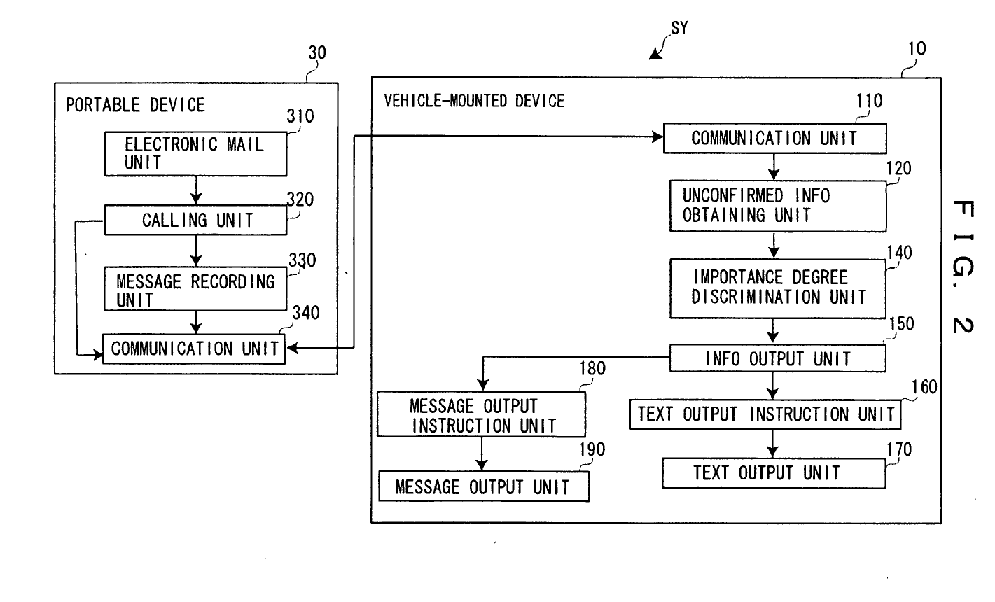

Referring to FIG. 2, a function structure of an information communication system SY having the vehicle-mounted device 10 and the portable device 30 will be explained. The portable device 30 has an electronic mail unit 310, a calling unit 320, a message recording unit 330 and a communication unit 340 as main functional components.

The electronic mail unit 310 performs an electronic mail function by the portable device 30 and includes an electronic mail receiving unit, an electronic mail generation unit and an electronic mail sending unit. The electronic mail unit 310 also includes a mail ID provision unit for providing a mail ID identifying each electronic mail to received electronic mails. The calling unit 320 performs a calling function by the portable device 30 and includes an outgoing call unit and an incoming call unit. The calling unit 320 also includes a phone ID provision unit for providing a phone ID identifying each incoming call to incoming calls.

The message recording unit 330 performs a message recording function (function which records an audio message of a caller) by the portable device 30. A message memo recorded by the message recording unit 330 is stored in a predetermined storage area in the portable device 30. The communication unit 340 performs input/output (transmission/reception) of information with the vehicle-mounted device 10, and, in the embodiment, is mainly used for sending the unconfirmed information and receiving output completion information (information showing electronic mails and message memos already output).

When the portable device 30 receives the output completion information from the vehicle-mounted device 10, the electronic mail unit 310 or the message recording unit 330 performs already-read process. More specifically, an output completed portion of the electronic mail specified by the mail ID is rendered in an already-read state (an already-read portion and an unread portion are identifiably displayed). In a case that an output overall of an electronic mail is completed, the electronic mail itself is made to be in the already-read state (stop displaying of “there's an unread mail”). Further, the missed call specified by the phone ID is made to be in the already-read state. Also, in a case that an output of the message memo is completed, the message memo is deleted and a display of “there's a message memo” is deleted together with the above deletion. In this case, the deletion of the message memo is not essential and the message memo may be made in an already reproduced state instead of the message memo deletion.

On the other hand, the vehicle-mounted device 10 includes a communication unit 110, an unconfirmed information obtaining unit 120, an importance degree discrimination unit 140, an information output unit 150, a text output instruction unit 160, a text output unit 170, a message output instruction unit 180 and a message output unit 190.

The communication unit 110 performs input/output information with the portable device 30. The unconfirmed information obtaining unit 120 is used to obtain unconfirmed information which is information unconfirmed by the user in the portable device 30. The communication unit 110 and the unconfirmed information obtaining unit 120 have the communication section 19 as main element. As described above, the “unread mail information” regarding one or more electronic mails in an unread state in the portable device 30 when a communication by the communication unit 110 is established and the “missed call information” regarding one or more missed calls arrived before a communication by the communication unit 110 is established as the “unconfirmed information” are obtained by the unconfirmed information obtaining unit 120. The “unread mail information” includes the number of unread mails, a mail ID of each unread mail, a mail received date, sender's name, a sender's (source) address, an electronic mail text, a title, an attached file and the like. Also, the “missed call information” includes the number of missed calls, a phone ID of each missed call, a call received date and time, a caller's name, a caller's (source) phone number, existence/nonexistence of memo in absence and of message memo, message memo and the like.

The importance degree discrimination unit 140 discriminates importance degree of one or more electronic mails and one or more missed calls included in the unconfirmed information which has been obtained by the unconfirmed information obtaining unit 120, and has the controller 20 as main element. The importance degree of an electronic mail can be discriminated based on at least a piece of information such as a priority flag (mail header) added to the electronic mail, a sender's address and existence/nonexistence for breaking a seal confirmation. For example, in terms of the “sender's address”, an address including a predetermined character string may be discriminated as having high degree of importance. Further, the degree of importance may be discriminated in accordance with whether the sender's address has been stored or not in the telephone book (address book) stored in the portable device 30 or the vehicle-mounted device 10. On the other hand, the importance degree of a missed call may be discriminated based on a caller's phone number or outgoing/incoming records. For example, in terms of the “caller's phone number”, a phone number having a predetermined number string (such as a dial code) may be discriminated as having high degree of importance. The importance degree may be discriminated in accordance with whether the caller's phone number has been stored or not in the telephone book (address book) in the portable device 30 or the vehicle-mounted device 10. In terms of the “outgoing/incoming records”, the importance degree may be discriminated in accordance with whether the caller's phone number has been recorded in the outgoing/incoming records in the portable device 30 or the vehicle-mounted device 10. The importance degree may be discriminated at the vehicle-mounted device 10 with the unconfirmed information sent from the portable device 30 or based on information obtained before/after reception of the unconfirmed information. A discrimination result discriminated based on these pieces of information at the portable device 30 may be obtained by the vehicle-mounted device 10. In the latter case, the importance degree discrimination unit 140 discriminates degree of importance based on the discrimination result obtained from the portable device 30.

The information output unit 150 displays or outputs audibly the unconfirmed information (unread mail information and/or missed call information) obtained by the unconfirmed information obtaining unit 120, and has the controller 20, the display 14 and the speaker 16 as main elements. The information output unit 150 displays or outputs audibly the unread mail information based on the importance degree of one or more electronic mails included in the unread mail information, and displays or outputs audibly the missed call information based on the importance degree of one or more missed calls included in the missed call information.

FIG. 3 shows a display example by displaying an output of the unconfirmed information (an example of an unconfirmed information display screen). Thus, on the unconfirmed information display screen, a screen title 51 (there exists the unconfirmed information), missed call information 52, unconfirmed mail information 53, a confirmation button 61 and a close button 62 are displayed. As the missed call information 52, the number of missed calls 55 and information 58 regarding a missed call which has been discriminated as having high degree of importance by the importance degree discrimination unit 140 are displayed. As the information 58 regarding a missed call, information regarding a caller (a caller's name or a phone number), an incoming call date and time, and existence/nonexistence of a message memo (message information) are displayed. If there is a message memo, a message and select buttons 66 (“OK” or “NG”) which urge the user to select whether the message should be read out or not are displayed. While, as the unread mail information 53, the number of unread mails 56 and information 59 regarding an electronic mail discriminated as having high degree of importance by the importance degree discrimination unit 140 are displayed. As information 59 regarding an electronic mail, information regarding a sender (a sender's name or a mail address), a tile thereof, and a message and select buttons 67 (“OK” or “NG”) which urge the user to select whether a text of the electronic mail is displayed or not are displayed. After selected “OK” or “NG” by a user with each select button 66, 67 displayed regarding the missed call and the unread mail, the user can confirm the message memo or the text of the electronic mail by touching the confirmation button 61 provided on the lower part of the screen. Further, it is possible to close the unconfirmed information display screen by touching the close button 62 without selecting each select button 66, 67.

Turning back to the explanation of FIG. 2, the text output instruction unit 160 instructs text output of an electronic mail discriminated as having high degree of importance, and has the touch panel 15 and the microphone 18 as main elements. More specifically, in the case that the unconfirmed information display screen (see FIG. 3) is displayed as explained above, the text output instruction unit 160 is implemented with the select button 67 included in the unread mail information 53 and the confirmation button 61 provided on the lower part of the screen. The select button 67 and the confirmation button 61 can be selected with an audio operation through the microphone 18.

The text output unit 170 displays or outputs audibly a text of an electronic mail discriminated as having high importance degree by the importance degree discrimination unit 140 in accordance with an instruction from the text output instruction unit 160, and has the controller 20, the display 14 and the speaker 16 as main elements. In the embodiment, the display 14 mainly performs the output.

The message output instruction unit 180 instructs to output a message memo of a missed call discriminated as having high degree of importance, and has the touch panel 15 and the microphone 18 as main elements. More specifically, in the case that the unconfirmed information display screen (see FIG. 3) as above is displayed, the message output instruction unit 180 is implemented with the select button 66 included in the missed call information 52 and the confirmation button 61 provided on the lower part of the screen. As the text output instruction unit 160, these buttons can be operated audibly (selection operation) through the microphone 18.

The message output unit 190 displays or outputs audibly a message memo of a missed call discriminated as having high degree of importance by the importance degree discrimination unit 140 in accordance with an instruction from the message output instruction unit 180, and has the controller 20, the display 14 and the speaker 16 as main elements. In the embodiment, the speaker 16 mainly performs the audio output (reading-out).

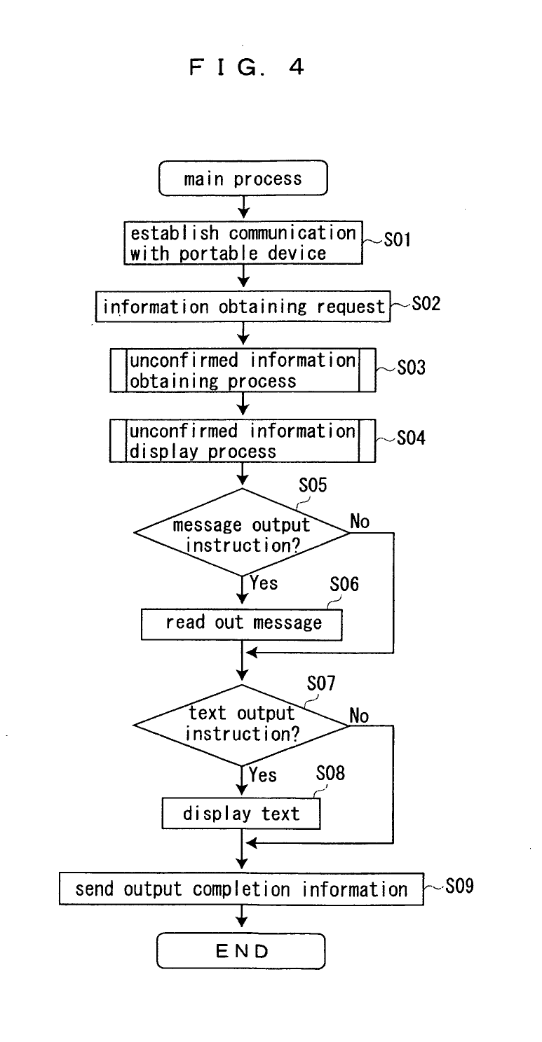

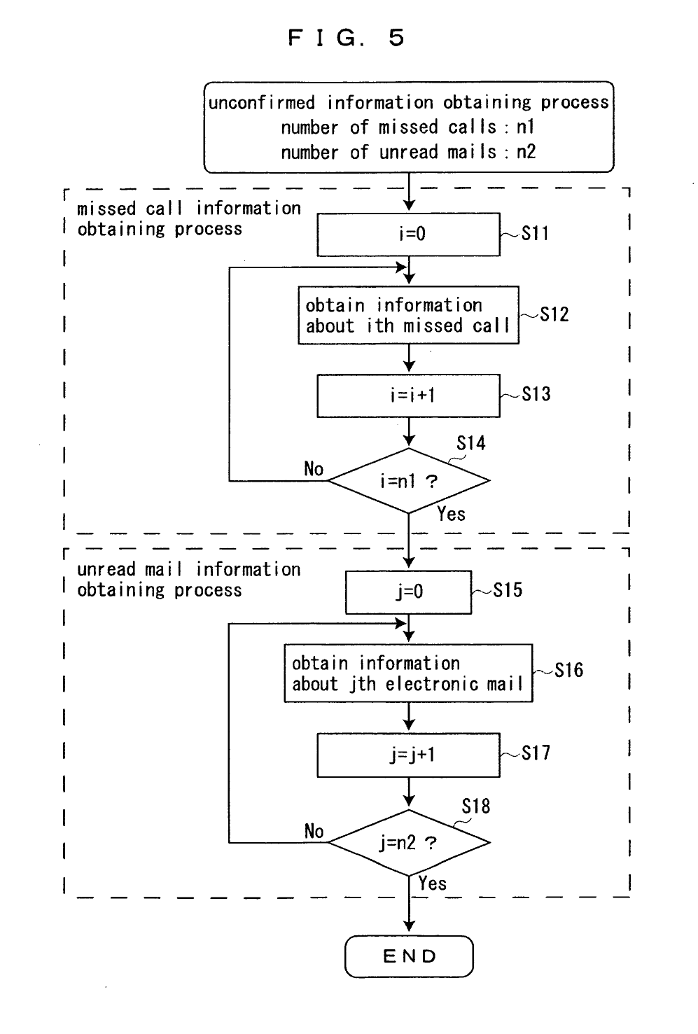

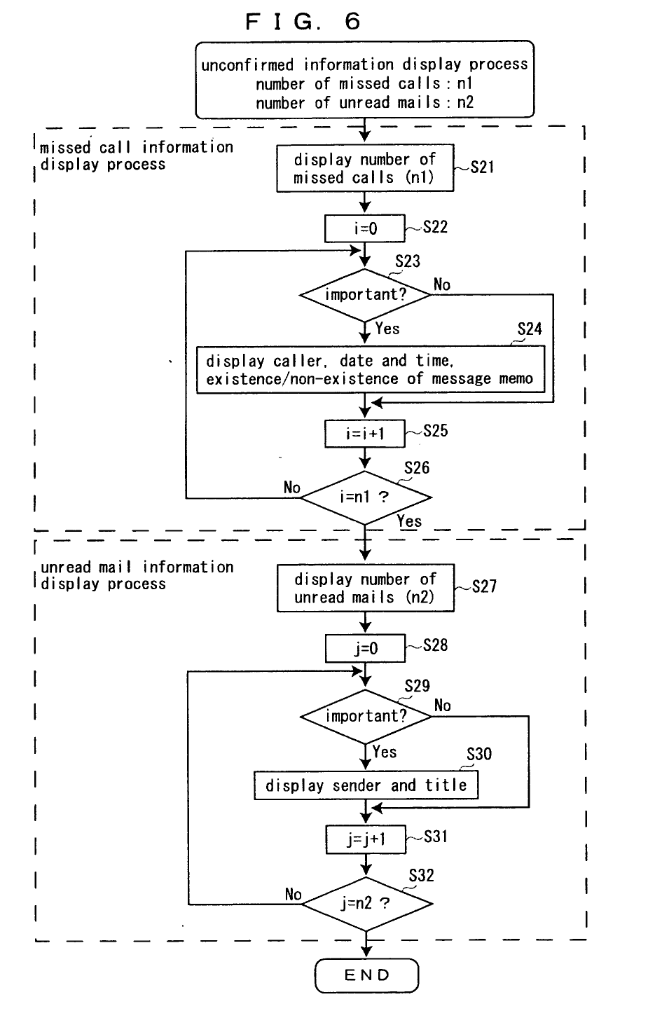

Referring to flowcharts of FIGS. 4-6, an information output process by the vehicle-mounted device 10 will be explained. FIG. 4 is a main flowchart of the information output process and FIGS. 5 and 6 are sub-flowcharts thereof. In this case, it is assumed that the portable device 30 capable of communicating with the vehicle-mounted device 10 is in a vehicle and a missed call and/or an unread mail are/is in the portable device 30.

As described in FIG. 4, when the vehicle-mounted device 10 establishes a communication with the portable device 30 (S01), an information obtaining request is output to the portable device 30 (S02). The vehicle-mounted device 10 obtains unconfirmed information sent by the portable device 30 in correspondence to the information obtaining request (S03). The unconfirmed information obtaining process corresponding to S03 will be explained with reference to FIG. 5 later. Then, the vehicle-mounted device 10 displays the obtained unconfirmed information (see S04 of FIG. 4). The unconfirmed information display process corresponding to S04 will be explained with reference to FIG. 6 later.

Thereafter, whether there is an output instruction for a message memo from a user or not is discriminated (S05), and if it exists (S05:Yes), the message memo is read out through the speaker 16 (S06). In a case that a plurality of output instructions of message memos are output, a plurality of message memos are read out sequentially in S06. Likewise, whether there is an output instruction for an electronic mail text from the user or not is discriminated (S07), and if it exists (S07:Yes), the electronic mail text is displayed on the display 14 (S08). Also in this case, when a plurality of output instructions of electronic mail texts are made, a plurality of electronic mail texts are displayed sequentially.

After completing these information outputs, the vehicle-mounted device 10 sends output completion information to the portable device 30 (S09). At this moment, a phone ID of the missed call in which a message memo has been recorded and/or a mail ID of the electronic mail are/is added to the output completion information. When the portable device 30 obtains the output completion information from the vehicle-mounted device 10, the corresponding missed call (message memo) and/or the electronic mail are/is performed with an already-read process based on the telephone ID and the mail ID included in the output completion information.

In the flowchart above, after the message memo being read out, the electronic mail text is displayed, but the order may be reversed, or displaying and reading-out may be performed in parallel. In terms of the output method, a message memo may be displayed and an electronic mail text may be read out, or a message memo and an electronic mail text may be output (displayed or read out) by a same output method. Further, the user may set an output method respectively for a message memo and an electronic mail text.

Referring to the flowchart of FIG. 5, the unconfirmed information obtaining process will be explained. The vehicle-mounted device 10, in the unconfirmed information obtaining process, firstly resets a value of i indicating the number of processed missed calls (S11), and obtains information regarding iₜₕ place missed call from the portable device 30 (S12). Then, the value of i is incremented (513), and, until the value of i equals to the number of missed calls n1 stored in the portable device 30 (S14:Yes), S11 to S14 are repeated. The processes of S11 to S14 indicate a missed call information obtaining process.

Thereafter, the vehicle-mounted device 10 resets a value of j indicating the number of processed unread mails (S15), and obtains information regarding jₜₕ place electronic mail (unread mail) from the portable device 30 (S16). Then, the value of j is incremented (S17), and, until the value of j equals to the number of unread mails n2 stored in the portable device 30 (S18:Yes), S15 to S18 are repeated. The processes of the steps S15 to S18 indicate an unread mail information obtaining process.

Thus, the unconfirmed information obtaining process (see S03 of FIG. 4) can be achieved by the missed call information obtaining process and the unread mail information obtaining process. The processing order of the missed call information obtaining process and the unread mail information obtaining process may be reversed or in parallel.

Referring to the flowchart of FIG. 6, the unconfirmed information display process will be explained. The vehicle-mounted device 10 displays, in the unconfirmed information display process, the number of missed calls (n1) based on an obtained result from the missed calls information obtaining process (see S21, and numeral 55 in FIG. 3). The value of i indicating the number of processed missed calls is reset (S22), and importance degree of the iₜₕ missed call is discriminated (S23). When it is discriminated as important (S23:Yes), the caller, the incoming date and time and the existence/nonexistence of a message memo of the iₜₕ missed call (see S24, and numeral 58 in FIG. 3). Then, the value of i is incremented (S25), and until the value of i equals to the number of missed calls n1 (S26:Yes), the steps S23 to S26 are repeated. The processes of the steps S21 to S26 indicate the missed call information display process.

Subsequently, the vehicle-mounted device 10 displays the number of unread mails (n2) based on the obtained result from the unread mail information obtaining process (see step 27, and numeral 56 in FIG. 3). The value of j indicating the number of processed unread mails is reset (S28), and importance degree of the jₜₕ electronic mail is discriminated (S29). When it is discriminated as important (S29:Yes), the caller and the title of the jₜₕ electronic mail are displayed (see S30, and numeral 59 in FIG. 3). Then, the value of j is incremented (S31), and until the value of j equals to the number of unread meals n2 (step S32:Yes), the steps S29 to S32 are repeated. The processes of the steps S27 to S32 indicate the unread mail information display process.

Thus, the unconfirmed information display process (see S04 in FIG. 4) can be achieved with the missed call information display process and the unread mail information display process. The processing order of the missed call information display process and the unread mail information display process may be reversed or in parallel. In the missed call information display process, after the number of missed calls (n1) is displayed (see S21), the information of a missed call having high importance degree (see S24), whereas, they may be displayed simultaneously. The same holds for the unread mail information display process.

As explained above, according to the first embodiment, when the vehicle-mounted device 10 establishes a communication with the portable device 30, unconfirmed information (the missed call information and the unread mail information) seemed to be unconfirmed by a user is obtained from the portable device 30 and is output. Therefore, even if the user goes on board without noticing that there is unconfirmed information on the portable device 30, the user can surely confirm the information by the output from the vehicle-mounted device 10.

Further, in terms of the missed call information and the unread mail information, since only an electronic mail and a missed call having high degree of importance are displayed, a user can save time for confirmation and can not be affected on safety driving. Concerning objects having high degree of importance, a text of the electronic mails or the message memo can be output based on an output instruction from the user, thereby the user can confirm the details thereof immediately.

In the above embodiment, unread mail information is obtained about an electronic mail, but it may be possible to obtain new mail information regarding a new mail which is received by the portable device 30 after a communication has been established and to output from the vehicle-mounted device 10. In this case, it is preferable that the vehicle-mounted device 10 display or output audibly the new mail information at the time of obtaining the new mail information from the portable device 30. According to the configuration, a user can confirm information immediately about an electronic mail received after a communication has been established. Further, in this case, it is preferable that the importance degree discrimination unit 140 discriminate degree of importance of an electronic mail received after a communication has been established and the information output unit 150 output new mail information based on the discriminated degree of importance. Still further, in a case that the text output instruction unit 160 instructs about an output of the new mail information, it is preferable that the text output unit 170 display or output audibly a text of the electronic mail at that point.

Also, in the above embodiment, detailed information of electronic mail only having high degree of importance is displayed as unread mail information (see numeral 58 in FIG. 3), but detailed information of an electronic mail having low degree of importance may be displayed. In this regard, it is preferable that each electronic mail be displayed in a state that the degree of importance thereof can be acknowledged by a user. Further, in a case that information about an electronic mail having high degree of importance in unread mail information is not included, the unread mail information itself may not be displayed.

Modifications regarding these electronic mails may be adapted to missed calls. In other words, in a case that an incoming call is received by the portable device 30 after a communication has been established (for example, while a vehicle is moving) and a user (driver) does not answer the phone, missed call information may be output from the vehicle-mounted device 10. Further, detailed information of a missed call having low degree of importance may be displayed. In a case that information about a missed call having high degree of importance is not included in the missed call information, the missed call information itself may not be displayed.

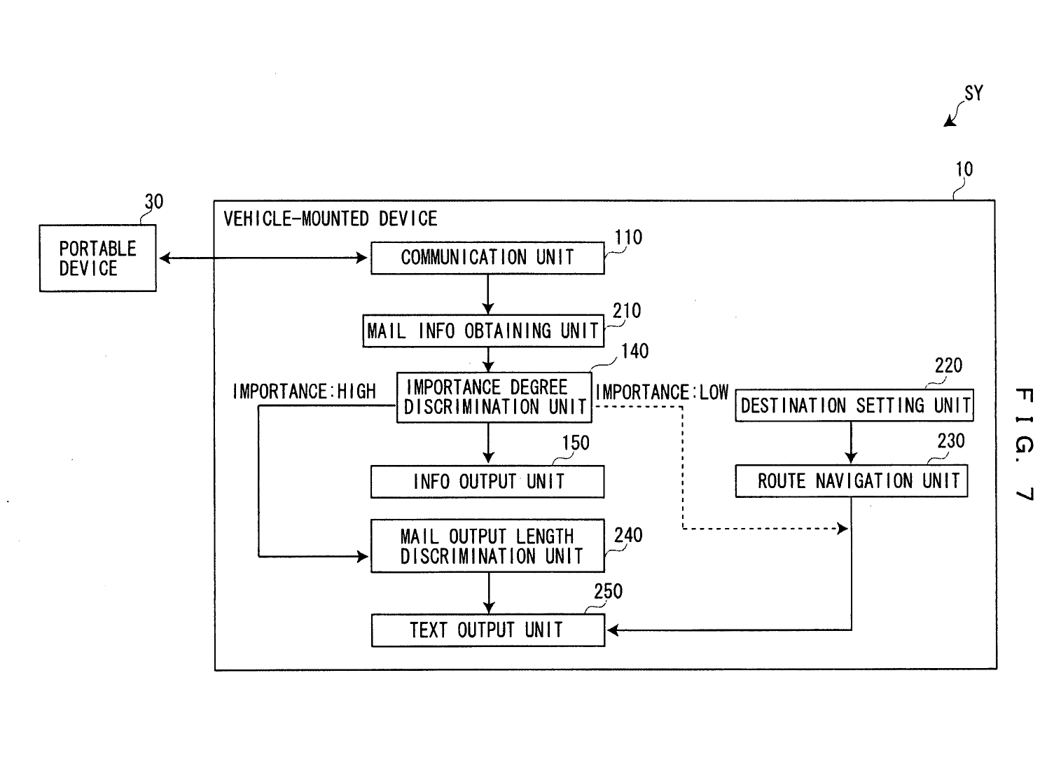

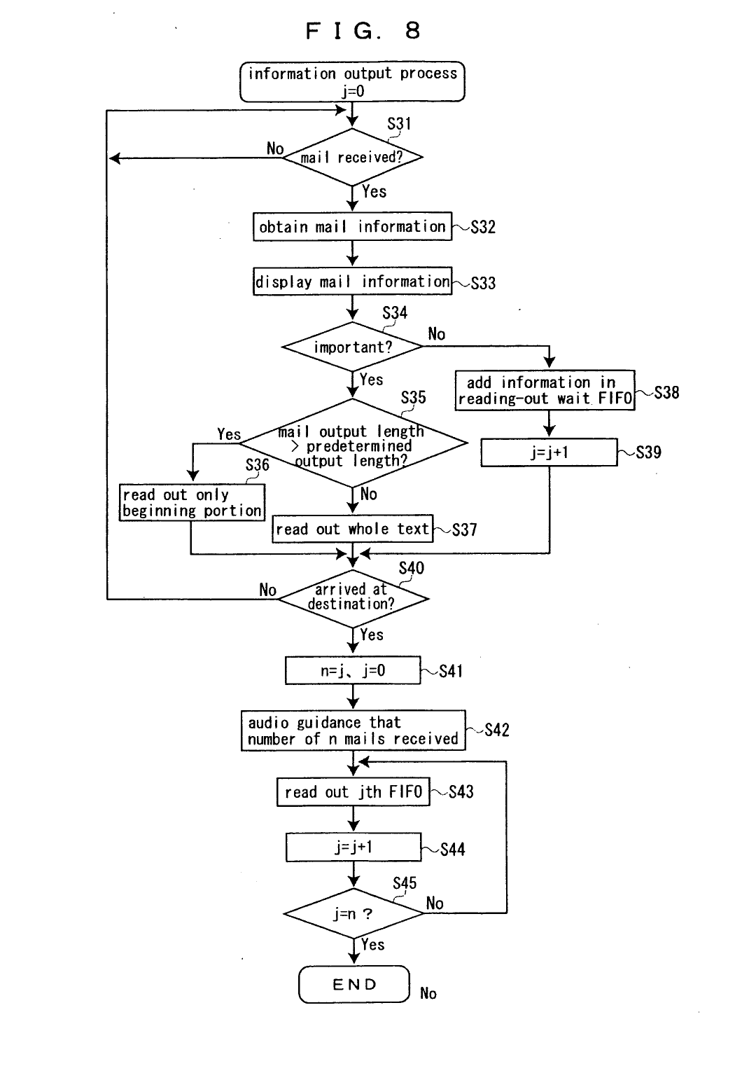

Referring to FIGS. 7 and 8, the second embodiment of the invention will be explained. In the first embodiment above, a text of an electronic mail having low degree of importance is not output on the vehicle-mounted device 10, but this embodiment differs in that a text of an electronic mail having low degree of importance is output after route navigation has been completed. Also, this embodiment differs in that a text of an electronic mail having high degree of importance is output without asking an output instruction by a user, and output length of a text in an electronic mail is discriminated regarding text output. Different points from the first embodiment will be explained hereinbelow. In this embodiment, an electronic mail is only mentioned and an explanation for a missed call will be omitted. Information about a received electronic mail is refereed to as only “mail information”, regardless of whether the electronic mail was received before or after a communication had been established (whether it is an unread mail or a newly received mail).

FIG. 7 shows a functional block diagram of an information communication system SY according to the second embodiment. The structure of the portable device 30 is the same as that in the first embodiment and the explanation thereof will be omitted. Further, regarding the vehicle-mounted device 10, structure elements having the same function as those in the first embodiment are referred with the same numbers and the explanation thereof will be omitted.

The vehicle-mounted device 10 has, as main function structures, the communication unit 110, a mail information obtaining unit 210, the importance degree discrimination unit 140, the information output unit 150, a destination setting unit 220, route navigation unit 230, a mail output length discrimination unit 240, and a text output unit 250.

The mail information obtaining unit 210 obtains mail information (unread mail information or new mail information) via the communication unit 110. The destination setting unit 220 sets a destination of the vehicle and includes the controller 20 and the map database 25 as main structure elements. Also, the route navigation unit 230 searches a route to the destination set by the destination setting unit 220 and guides the route (including route navigation display and audio guidance), and includes the autonomous navigation sensor 13, the controller 20 and the map database 25 as main structure elements.

The mail output length discrimination unit 240 discriminates whether output length of a text in an electronic mail (referred as “mail output length” hereinbelow) is beyond predetermined output length and includes the controller 20 as main structure element. The “mail output length” indicates a display area size or a display time needed for displaying a text of an electronic mail, or output time needed for outputting audibly the text of the electronic mail. Further, the display area size and the output time can be calculated based on a predetermined algorithm in which the number of letters included in the electronic mail (characters such as pictograms and signs, and letters included in attached files may be included), data amount, existence/non-existence of an attached file and the like are parameters therefor.

The text output unit 250 displays or outputs audibly a content of an electronic mail discriminated as having high degree of importance by the importance degree discrimination unit 140, following the output from the information output unit 150. On the other hand, a text of an electronic mail discriminated as having low degree of importance is displayed or output audibly after a route navigation has been completed (in short, after arriving at the destination). Further, when the mail output length discrimination unit 240 discriminates that mail output length of an electronic mail discriminated as having high degree of importance is beyond the predetermined output length, the content output unit 250 displays or outputs audibly only a beginning portion (the predetermined number of letters) of the text in the electronic mail.

Referring to the flowchart of FIG. 8, an information output process of the vehicle-mounted device 10 according to the second embodiment will be explained. A text in an electronic mail is output audibly (read out). When the vehicle-mounted device 10 receives receipt notification of an electronic mail from the portable device 30 (S31: Yes), then, obtains mail information (S32) and displays it (S33). S31 to S33 processes electronic mails one by one received after the portable device 30 has established a communication with the vehicle-mounted device 10. Regarding electronic mails received before the communication has been established, one or more unread electronic mails are processed as a whole.

Then, the vehicle-mounted device 10 discriminates degree of importance of the electronic mail (S34). When the degree of importance is high (S34: Yes), whether the mail output length (reading-out time of the text in the electronic mail) is beyond the predetermined output length (criterion time) or not is discriminated (S35). In a case that the mail output length is beyond the predetermined output length (S35: Yes), a beginning portion of the text in the electronic mail is read out through the speaker 16 (S36). On the other hand, when the mail output length is not beyond the predetermined output length (S35: No), a whole text in the electronic mail is read out (S37). When the importance degree of the electronic mail is not high (S34: No), information is added in a reading-out queue FIFO (S38), and the number of unread mails (j) is incremented (S39). The “reading-out queue FIFO” indicates a digital circuit having a buffering function of first-in and first-out.

Then, whether the vehicle has arrived at the destination or not is discriminated (S40). When the vehicle has not arrived at the destination (S40: No), S31 to S39 are repeated. When the vehicle has arrived at the destination (S40: Yes), the number of mails in the reading-out queue FIFO (n=j) is checked, the number of processed mails (j) is reset (S41), and audio guidance informing that the number of n mails are received is performed. Then, jₜₕ FIFO is read out (S43), the number of processed mails (j) is incremented (S44). S43 to S45 are repeated until j=n (S45: Yes). After reading out all mails in the reading-out queue FIFO, the information output process is terminated.

As explained above, according to the second embodiment, regarding an electronic mail discriminated as having high degree of importance, since the mail information is displayed (see S33) and then, the content thereof is output audibly (see S36 and S37), a user can confirm the content of an electronic mail immediately, without extra operations. Further, in this case, since whether the output length of the text of an electronic mail is beyond the predetermined output length or not is discriminated (see S35) and when it is beyond the predetermined output length, the beginning portion thereof is output (see S36). Therefore, a user can save confirmation time and cannot be bothered much by influence against safety driving. On the other hand, regarding an electronic mail discriminated as having low degree of importance, since the text thereof is output after the route guidance has been completed (see S43), it is possible to avoid interference against safety driving.

In the above second embodiment, when the mail output length is beyond the predetermined output length, the predetermined number of letters in the beginning portion is read out (see S35 and S36), but the predetermined number of letters may be set by a user. Further, a predetermined ratio such as a former part (half of the whole) when the electronic mail is divided into two may be read out in place of the predetermined number of letters. Still further, to resolve a sense of discomfort when only the beginning portion is read out, it may be possible to read out till the end of a sentence (till a period) within the predetermined number of letters, or may be possible to read out till the end of a sentence including the last letter of the predetermined number of letters.

When only the beginning portion is read out, a user is urged to select whether the remaining portion should be read out or not. It is preferable that the remaining portion be output when the user instruct to output. In the case that the remaining portion is output, it is preferable that the output begin from the beginning of a sentence in which the initial letter of the remaining portion belongs or from the beginning of a paragraph in which the initial letter of the remaining portion belongs. According to this configuration, it is possible to remove a sense of discomfort or false recognition caused by outputting from the middle of the sentence.

Further, in the second embodiment, regarding the electronic mail discriminated as having low degree of importance, the text thereof is output after the route guidance has been completed, but it is possible to output the text of the electronic mail when the vehicle has stopped (when a parking brake was activated). According to this configuration, since a text of an electronic mail is confirmed when a vehicle has stopped, it is possible to avoid interference against safety driving.

Also, in the second embodiment, only electronic mails are mentioned, but incoming calls can be applied to. In this case, a text output of an electronic mail can be read as an output of a message memo.

As above, the two embodiments have been explained, but each embodiment is not necessarily to be substantialized independently and each embodiment may be combined. Further, in the above two embodiments, the missed call information and the unread mail information is exemplified as the “unconfirmed information”, but the vehicle-mounted device 10 may confirm other various pieces of error information, inquiry information to a user, download confirmation of applications, and service information notified by various services such as recent news and the like. In other words, information which a user needs to operate to confirm and which the confirmation operation has not been made may be displayed or output audibly as the “unconfirmed information”.

Further, in the above embodiments, the recorded message memo is read out by the “message recording function” provided in the portable device 30, but the recorded message may be read out by an “answer phone function” provided as a network service by a mobile-service provider. In this case, the vehicle-mounted device 10 instructs an output for a memo in absence to the portable device 30, the portable device 30 obtains the memo in absence based on the output instruction from the “answer phone function” provided by a mobile-service provider, and the obtained message in absence is provided to the vehicle-mounted device 10.

Further, in the above embodiments, various pieces of information is output as the missed call information or the unread mail information (see FIG. 3), but only information (flag information) regarding existence/non-existence of missed calls or of unread mails may be output. In other words, when the output is made by displaying, only “a missed call/no missed call” or “an unread mail/no unread mail” may be displayed as the missed call information or the unread mail information. Information about existence/non-existence of missed calls or unread mails may always be displayed as icons. Still further, when there is the missed call information or the unread mail information, it is displayed, and when there is not the missed call information or the unread mail information, nothing may be displayed.

Further, in the above embodiments, the vehicle-mounted device 10 confirms the unread mails and missed calls, but these pieces of information may be confirmed by operating the portable device 30 after the communication establishment with the vehicle-mounted device 10. When the unconfirmed information (the missed call information or the unread mail information) is always output to display at the vehicle-mounted device 10 and the unread mails and the missed calls have been confirmed by operation with the portable device 30, it is preferable that the vehicle-mounted device 10 obtain the information (confirmation completion information) (a confirmation completion information obtaining device), display and status of the missed call information or the unread mail information be updated. More specifically, it is preferable that, upon receiving the confirmation completion information, the information output device 150 delete information about already confirmed electronic mails from the unread mail information or delete information about already confirmed missed calls from the missed call information. According to this configuration, the vehicle-mounted device 10 can recognize that the missed calls or electronic mails have been confirmed. Also, regardless of confirming information at the portable device 30, burden in which the same information should be confirmed at the vehicle-mounted device 10 can be avoided. Even when the vehicle-mounted device 10 does not always output to display the unconfirmed information, it is preferable that the unconfirmed information be stored in the vehicle-mounted device 10 and the display and the status for the missed call information or the unread mail information be updated when a user calls for the unconfirmed information.

Further, it is possible to provide each component in the vehicle-mounted device 10 and the portable device 30 as program. Still further, it is possible to provide a recording medium (not shown in figures) in which the program has been stored. In short, the scope of the invention includes a program causing a computer to function as each component of the vehicle-mounted device 10 and the portable device 30, and a recording medium having the program therein. The invention can be applied to communication devices such as a “wrist watch”, a “personal computer (portable type)” in addition to the vehicle-mounted device 10. Modifications may be possible without departing from the scope of the invention.

### REFERENCE NUMERALS

10: vehicle-mounted device
11: GPS receiver
12: antenna
13: autonomous navigation sensor
14: display
15: touch panel
16: speaker
18: microphone
19: communication section
20: controller
21: CPU
22: ROM
23: RAM
25: map database
26: registration database
27: connection bus
30: portable device
52: missed call information
53: unread mail information
SY: information communication system

1-19. (canceled)

20. A communication device comprising:
a communication unit that communicates with a portable device having at least an electronic mail function;
a new mail information obtaining unit that obtains new mail information from the portable device regarding an electronic mail received after communication establishment by the communication unit; and
an information output unit that displays or outputs audibly the obtained new mail information.

21. The communication device according to claim 20 further comprising an importance degree discrimination unit that discriminates degree of importance of the electronic mail, wherein the information output unit displays or outputs audibly the new mail information based on degree of importance of the received electronic mail.

22. The communication device according to claim 20 further comprising an unconfirmed information obtaining unit that obtains from the portable device unconfirmed information which is information unconfirmed by a user in the portable device at a time of communication establishment by the communication unit, wherein the information output unit displays or outputs audibly the obtained unconfirmed information.

23. The communication device according to claim 22 wherein the portable device includes a call function, and the unconfirmed information obtaining unit obtains unread mail information regarding one or more unread electronic mails at a time of communication establishment by the communication unit or missed call information regarding one or more missed calls received before communication establishment by the communication unit as the unconfirmed information.

24. The communication device according to claim 23, wherein the portable device includes a message recording function, and the unconfirmed information obtaining unit obtains message information regarding one or more message memos recorded by the message recording function in accordance with one or more of the missed calls as at least a portion of the missed call information.

25. The communication device according to claim 23 further comprising an importance degree discrimination unit that discriminates each importance degree of one or more of the electronic mails or of one or more of the missed calls, wherein the information output unit displays or outputs audibly the unread mail information based on importance degree of one or more of the electronic mails when degree of importance of one or more of the electronic mails is discriminated, and displays or outputs audibly the missed call information based on importance degree of one or more of the missed calls when degree of importance of one or more of the missed calls is discriminated.

26. The communication device according to claim 25, wherein the information output unit outputs at least information about a sender or a title regarding an electronic mail discriminated as having high degree of importance among one or more of the electronic mails as at least a portion of the unread mail information, and outputs at least information about a caller or a received date and time regarding a missed call discriminated as having high degree of importance among one or more of the missed calls as at least a portion of the missed call information.

27. The communication device according to claim 21 further comprising:
a text output instruction unit that instructs text output of an electronic mail discriminated as having high degree of importance by the importance degree discrimination unit; and
a text output unit that displays or outputs audibly a text of the electronic mail discriminated as having high degree of importance based on an instruction from the text output instruction unit.

28. The communication device according to claim 21 further comprising a text output unit that displays or outputs audibly a text of an electronic mail discriminated as having high degree of importance by the importance degree discrimination unit following an output from the information output unit.

29. The communication device according to claim 28 further comprising a mail output length discrimination unit that discriminates whether text output length of an electronic mail discriminated as having high degree of importance by the importance degree discrimination unit is beyond predetermined output length or not, wherein the text output unit displays or outputs audibly only a beginning portion of the text when the output length of the electronic mail is beyond the predetermined output length.

30. The communication device according to claim 21, wherein the importance degree discrimination unit discriminates degree of importance of the electronic mail based on at least. one pieces of information among a priority flag added to the electronic mail, the sender's address and existence/nonexistence for breaking a seal confirmation.

31. The communication device according to claim 27, wherein the communication unit sends output completion information indicating a mail ID of the electronic mail output from the text output unit to the portable device, and the output completion information is information that makes the portable device render the electronic mail corresponding to the mail ID in an already-read state on receipt of the output completion information.

32. The communication device according to claim 31, wherein the output completion information is information that renders an output completion portion of the electronic mail corresponding to the mail ID in an already-read state.

33. The communication device according to claim 25, wherein the portable device includes a message recording function, and the unconfirmed information obtaining unit obtains message information about one or more message memos recorded by the message recording function in accordance with one or more of the missed calls as at least a portion of the missed call information, the device further comprising a message output instruction unit that instructs to output a message memo of the missed call discriminated as having high degree of importance by the importance degree discrimination unit, and a message output unit that displays or outputs audibly the message memo of the missed call based on an instruction from the message output instruction unit.

34. The communication device according to claim 33, wherein the communication unit sends output completion information indicating the missed call which the message memo has been output by the message output unit to the portable device, and the output completion information is information that makes the portable device delete or render in an already reproduced state a message memo corresponding to the missed call on receipt of the confirmation completion information.

35. The communication device according to claim 23 further comprising a confirmation completion information obtaining unit that obtains confirmation completion information indicating the electronic mail or the missed call confirmed after communication establishment by the communication unit from the portable device, wherein the information output unit deletes information regarding the confirmed electronic mail from the unread mail information or deletes information regarding the confirmed missed call from the missed call information on receipt of the confirmation completion information.

36. An information communication system comprising the communication device according to claim 20 and the portable device.

37. A communication control method of a communication device capable of communicating with a portable device having at least an electronic mail function,
the communication device comprising steps of:
establishing communication with the portable device;
obtaining new mail information regarding an electronic mail received after communication establishment with the portable device; and
displaying or outputting audibly the obtained new mail information.

38. A computer readable medium encoded with a computer program for causing a computer to perform each step in the communication control method of the communication device as set forth in claim 37.

39. An information communication system comprising the communication device according to claim 21 and the portable device.
